(19) United States
(12) Patent Application Publication
(10) Pub. No.: US 2018/0295207 A1
(43) Pub. Date: Oct. 11, 2018

(54) ENDORSEMENTS RELEVANCE

(71) Applicant: Microsoft Technology Licensing, LLC, Redmond, WA (US)

(72) Inventors: Pujita Mathur, San Francisco, CA (US); Kwei-you Tao, San Francisco, CA (US); Ricardo Rivera Ayala, Sunnyvale, CA (US); Yo-Tzu Yeh, San Francisco, CA (US); Heidi Jaywing Wang, Cupertino, CA (US); Joey Bai, Sunnyvale, CA (US); Chao Zhang, Sunnyvale, CA (US)

(21) Appl. No.: 15/827,269

(22) Filed: Nov. 30, 2017

Related U.S. Application Data
(60) Provisional application No. 62/483,216, filed on Apr. 7, 2017.

(51) Int. Cl. H04L 29/08; G06F 17/30; G06Q 50/00

(52) U.S. Cl. CPC H04L 67/306; G06F 17/30958; H04L 67/10; G06F 17/30867; G06F 17/30035; G06Q 50/01

(57) ABSTRACT

A system, a machine-readable storage medium comprising instructions, and a computer-implemented method described herein are directed to a Quality Endorsement Engine. The Quality Endorsement Engine extracts content portions from content, accessible on a social network service, associated with a first member account. The Quality Endorsement Engine identifies at least one pre-defined skills identifier that corresponds to a respective topic of a respective content portion. The Quality Endorsement Engine determines that a second member account satisfies at least one quality endorser requirement with respect to the first member account. The Quality Endorsement Engine generates an endorsement prompt for the second member account. The Quality Endorsement Engine causes concurrent display of the content and the endorsement prompt in a social network content feed of the second member account in a user interface of a client device associated with the second member account.

### CROSS-REFERENCE TO RELATED APPLICATIONS

This application claims the benefit of priority to U.S. Provisional Patent Application entitled “Endorsements Relevance,” Ser. No. 62/483,216, filed Apr. 7, 2017, which is hereby incorporated herein by reference in its entirety.

### TECHNICAL FIELD

The subject matter disclosed herein generally relates to the technical field of special-purpose machines that prompt social network activity including software-configured computerized variants of such special-purpose machines and improvements to such variants, and to the technologies by which such special-purpose machines become improved compared to other special-purpose machines that prompt social network activity.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance with an example embodiment;

FIG. 3 is a block diagram showing example components of a Quality Endorsement Engine, according to some embodiments.

FIG. 4 is a block diagram showing a user interface, generated by the Quality Endorsement Engine, that includes an endorsement prompt, according to example embodiments;

FIG. 5 is a flowchart illustrating an example method, according to various embodiments;

FIG. 6 is a block diagram of an example computer system on which operations, actions and methodologies described herein may be executed, in accordance with an example embodiment.

### DETAILED DESCRIPTION

The present disclosure describes methods and systems for Quality Endorsement Engine in a professional social networking service (also referred to herein as a “professional social network,” “social network” or a “social network service”). In the following description, for purposes of explanation, numerous specific details are set forth in order to provide a thorough understanding of the various aspects of different embodiments of the subject matter described herein. It will be evident, however, to one skilled in the art, that the subject matter described herein may be practiced without all of the specific details.

A system, a machine-readable storage medium storing instructions, and a computer-implemented method are described herein are directed to Quality Endorsement Engine. The Quality Endorsement Engine extracts content portions from content, accessible on a social network service, associated with a first member account (such as a reference member account). The Quality Endorsement Engine identifies at least one pre-defined skills identifier that corresponds to (e.g., is associated with) a respective topic of a respective content portion. The Quality Endorsement Engine determines that a second member account (such as a target member account) satisfies at least one quality endorser requirement with respect to the first member account. The Quality Endorsement Engine generates an endorsement prompt for the second member account. The endorsement prompt includes the at least one pre-defined skills identifier that corresponds to the respective topic of the respective content portion. The Quality Endorsement Engine causes concurrent display of the content and the endorsement prompt in a social network content feed of the second member account.

Various embodiments of the Quality Endorsement Engine are directed to identifying one or more member accounts of a social network service who can provide highly-valuable for more meaningful) endorsements of skills of a reference member account. When the Quality Endorsement Engine determines a target member account satisfies requirements for being classified as a “quality endorser” of the reference member account, the target member account is provided an endorsement prompt to optionally endorse one or more skills of the reference member. The endorsement prompt is concurrently displayed, in a social network content feed of the target member account, with content posted by the reference member. In one embodiment, the endorsement prompt is displayed proximate to the content posted by the reference member account.

According to an example embodiment, the Quality Endorsement Engine detects an association between content and a reference member account of the social network service. For example, the Quality Endorsement Engine detects that reference member account has posted an article to the social network service. The Quality Endorsement Engine extracts one or more content portions from the content (e.g., the article posted to the social network service). The Quality Endorsement Engine generates a respective topic tag for each extracted portion of content, and stores the generated tags in a record of a database in association with the content). Each topic tag contains text that is descriptive of the subject matter of the corresponding content portion. The Quality Endorsement Engine standardizes the text of each topic tag with a predefined Skills identifier. As such, one or more skills that are related to the content have been identified by the Quality Endorsement Engine.

The Quality Endorsement Engine identifies a target member that satisfies one or more quality endorser requirements. The Quality Endorsement Engine concurrently displays the content and an endorsement prompt in a social network feed of the target member. The feed may be caused to be displayed in a user interface on a client device. The endorsement prompt includes one or more of the Skills identifiers that are related to the content. The Quality Endorsement Engine receives a selection of at least one of the Skills identifiers displayed in the endorsement prompt. Selection of a Skills identifier is classified by the Quality Endorsement Engine as a skill endorsement for the reference member by the target member account. In some example embodiments, the selective inclusion of the endorsement prompt in the content feed of only the members who are identified as quality endorsers improves the user interfaces of client devices at least based on the endorsement prompt being concurrently and proximately displayed with the content authored by the member being endorsed.

With regard to the quality endorsement requirements, an affiliation overlap is determined by accessing profile data of the first and second member accounts to determine whether they attended the same school at the same time or whether they worked at the same organization at the same time. An industry overlap is determined by accessing profile data of the first and second member accounts to determine whether both sets of profile data have the same industry descriptor tag. A connection strength value is determined by accessing profile data and social graphs of the first and second member accounts to determine whether there is a threshold number of similar profile attributes, or whether the member accounts share a threshold number of similar social network connections. A country overlap is determined by accessing profile data of the first and second member accounts to determine whether both sets of profile data have the same country descriptor tag (or geographic region descriptor tag).

A member account skill reputation score value associated with a member account of a member is calculated based on accessing profile data and member account data, and determining how many other member accounts have viewed that member account's profile page, how many endorsements have been received by that member account, and the professional seniority level of that member account. A professional seniority level may be determined based on a time span (e.g., period, duration, etc.) of a professional experience in the profile data, as well as keywords found in job titles and job descriptions of the profile data of that member account. Determining whether a member account is to be classified as a people leader is based on accessing the profile data of that member account to determine whether the member associated with that member account has a managerial role at an organization with a certain number of employees (e.g., at least 200 employees), or has keywords in a current job title (such as: “Partner”, “Director”, “C.F.O.”, “C.E.O.”, “C.O.O.”, or “Vice President”) in an organization of a certain size (e.g., no more than 10 employees).

in one embodiment, the target member account is identified by the Quality Endorsement Engine as a quality endorser based on satisfying the following quality endorser requirements: there is a presence of affiliation overlap between the target and reference member accounts—or—the connection strength value between the target and reference member accounts is calculated to be at or above the top 25^{th} percentile of a general pool of connection strength values between various member accounts. In addition, the target member account has a skill reputation score value (for one or more of the skill identifiers listed in the endorsement prompt) that is at least included in the top 50^{th} percentile of skill reputation score values for that particular skill—or—the target member account is classified as a people leader.

It is understood that various embodiments described herein include encoded instructions that comprise operations to generate a user interface(s) and various user interface elements. The user interface and the various user interface elements can be displayed to be representative of any type of data, operation, and calculation result described herein. In addition, the user interface and various user interface elements are generated by the Quality Endorsement Engine for display on a computing device, a server computing device, a mobile computing device, etc.

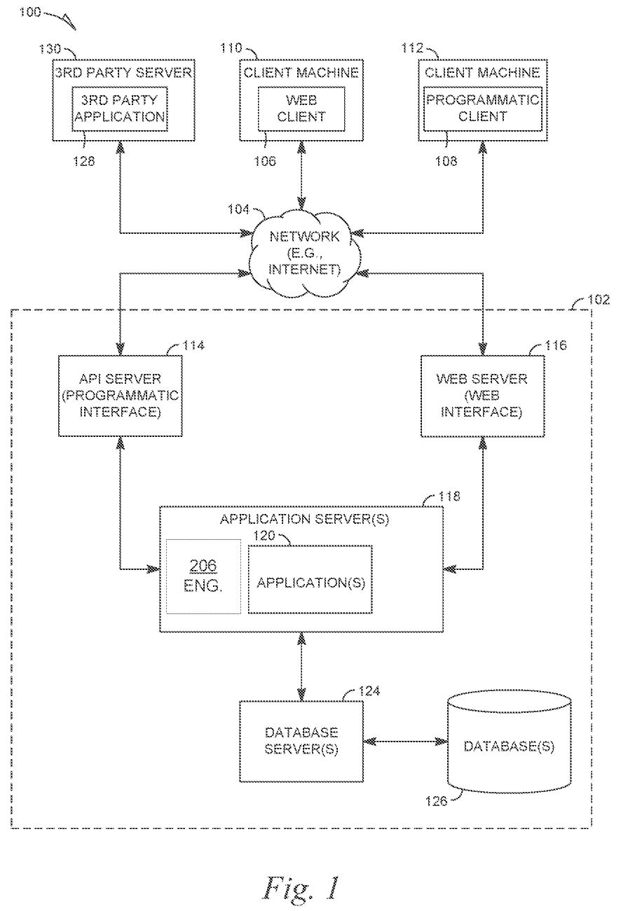

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

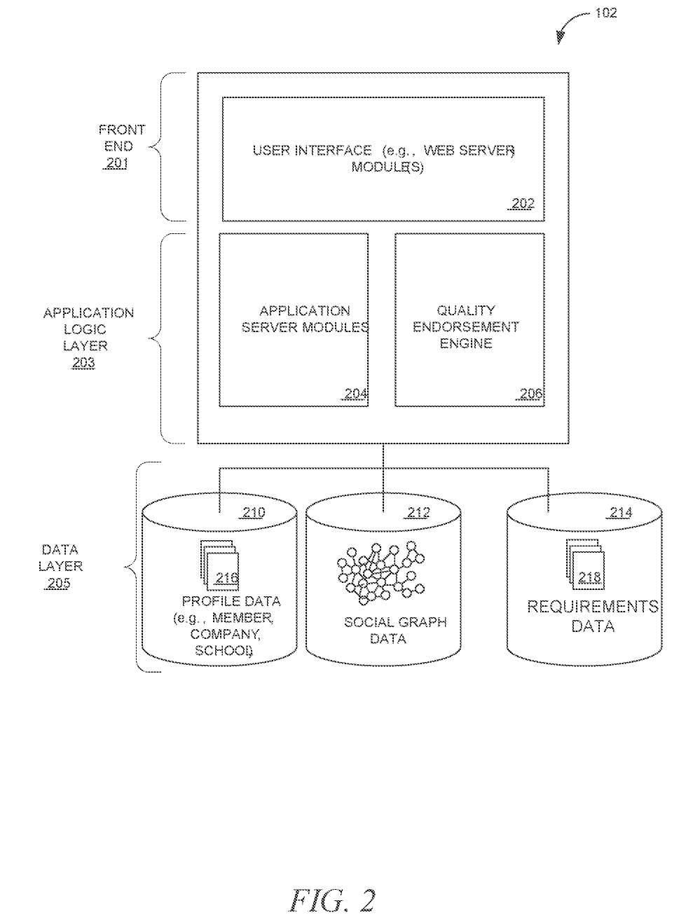

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and engines depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

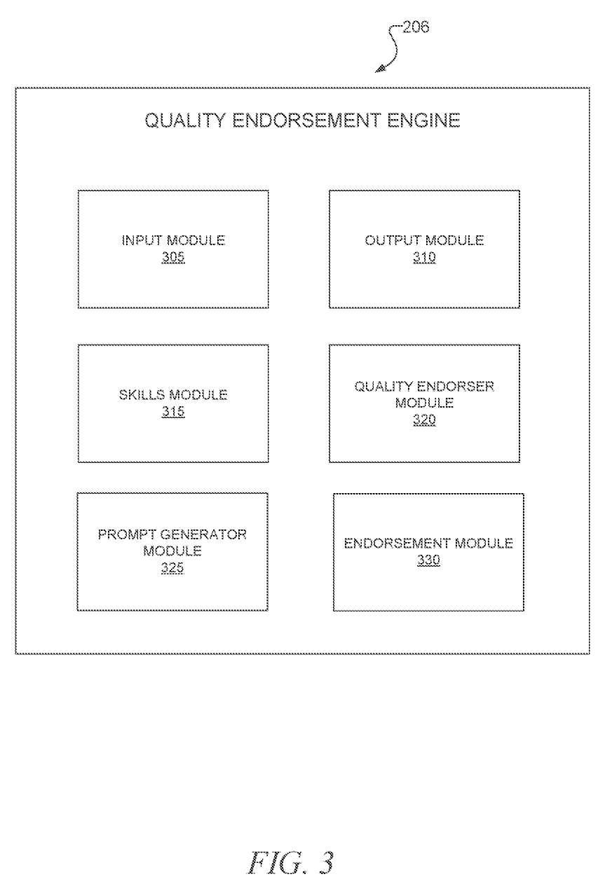

The data in the data layer 205 may be accessed, used, and adjusted by the Quality Endorsement Engine 206 as will be described in more detail below in conjunction with FIGS. 3-6. Although the Quality Endorsement Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure. In one embodiment, the data layer 205 further includes a database 214 that includes requirements data 218, such as various pre-defined quality endorser requirements.

FIG. 3 is a block diagram showing example components of a Quality Endorsement Engine 206, according to some embodiments.

The input module 305 is a hardware-implemented module that accesses, controls, manages and stores information related to any inputs from one or more components of system 102 as illustrated in FIG. 1 and FIG. 2. In various embodiments, the inputs include detecting content associated with a reference member account. For example, the Quality Endorsement Engine 206 detects content posted in the social network service by the reference member account. The output module 310 is a hardware-implemented module that controls, manages, transmits, and stores information related to any outputs to one or more components of system 100 of FIG. 1 (e.g., one or more client devices 110, 112, third party server 130, etc.). In some embodiments, the output is an endorsement of a skill of the reference member account by the target member account.

The skills module 315 is a hardware implemented module which manages, controls, stores, and accesses information related to generating topic tags of the content and matching text of the topic tags to standardized skill identifiers.

The quality endorser module 320 is a hardware implemented module which manages, controls, stores, and accesses information related to determining whether the target member account is to be classified as a quality endorser. For example, the Quality Endorsement Engine 206 determines whether the target member account satisfies one or more quality endorser requirements.

The prompt generator module 325 is a hardware implemented module which manages, controls, stores, and accesses information related to generating an endorsement prompt with one or more selectable skills identifiers that correspond with respective topic tags of the content. The prompt generator module 325 further manages, controls, stores, and accesses information related to concurrently displaying the endorsement prompt proximate to the content in the social network feed of the target member account.

The endorsement module 330 is a hardware implemented module which manages, controls, stores, and accesses information related to classifying the selection of a skill identifier from the endorsement prompt as an endorsement of a skill of the first member account by the second member account.

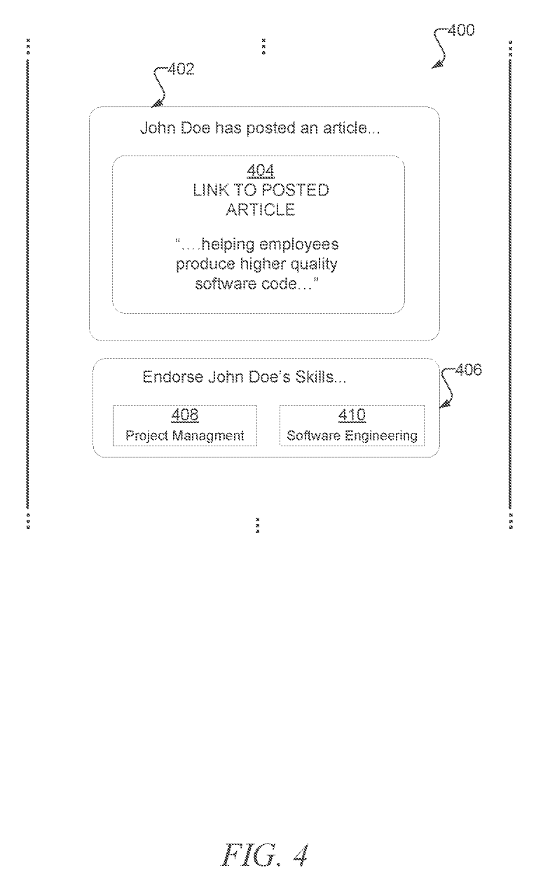

FIG. 4 is a block diagram showing a user interface 400, generated by the Quality Endorsement Engine 206, that includes an endorsement prompt, according to example embodiments. The user interface may be generated as a result of implementing one or more of the modules illustrated in FIG. 3, and is discussed by way of reference thereto.

The Quality Endorsement Engine 206 detects that first member account (associated with “John Doe”) has posted (i.e. uploaded) an article to the social network service. The subject matter (or topic) of the article pertains to helping employees produce higher quality software code, as an example. Topic tags of the article are extracted and standardized to match one or more predefined Skills identifiers, such as: “Software Engineering” and “Project Management.” Stated differently, the Quality Endorsement Engine 206 determines that the article is related to the skills of Software Engineering and Project Management.

The Quality Endorsement Engine 206 determines that a target member account satisfies the requirements for being defined as a “quality endorser” of the first member account's skills. Criteria for the quality endorsement requirements are based on any one or more of the following: an affiliation overlap, industry overlap, a connection strength value, a company overlap, a country overlap, a skill reputation score value of the second member account, or a people leader score value for second member account. Another quality endorsement requirement can be a requirement that the second member account has to have interacted with the content (i.e. the article) in some manner, such as any of the following: like, share, comment, or access the article for a predetermined minimum number of time.

A link 404 to the article is displayed in a user interface portion 400 of the target member account's social network content feed. Based on determining that the second member account is a quality endorser, an endorsement prompt 406 generated is displayed proximate to the link 404 to the article. The endorsement prompt 406 is a user interface component presented in the user interface 400 based on the determining that the second member account is a quality endorser. The endorsement prompt 406 includes selectable identifiers 408 and 410 for a “Software Engineering” skill and a “Project Management” skill, respectively. The Quality Endorsement Engine 206 receives a selection of the “Project Management” skill identifier 408 by the target member account. The Quality Endorsement Engine 206 classifies the selection of the “Project Management” skill identifier 408 in the endorsement prompt 406 as an endorsement of a skill of the first member account by the target member account.

The Quality Endorsement Engine 206 enhances (e.g., improves) the user interface 400 by generating and including a user interface component, the endorsement prompt 406, in the user interface 400, wherein the endorsement prompt 406 is generated and presented in a social network content feed of a target member in conjunction with a reference to a digital content item authored by the member being endorsed, and wherein the endorsement prompt 406 is generated and presented in the user interface 400 of a client device of the target member based on the Quality Endorsement Engine 206 identifying the target member as a quality endorser.

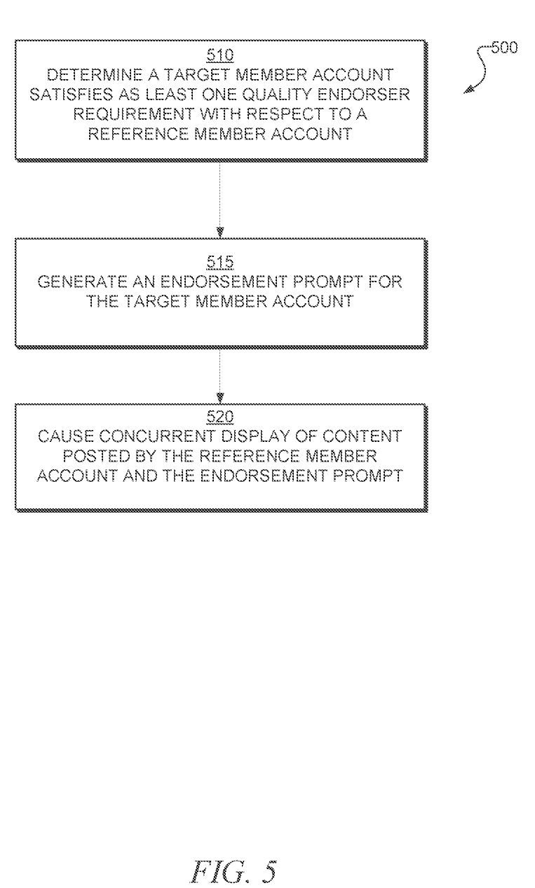

FIG. 5 is a flowchart 500 illustrating an example method, according to various embodiments.

At operation 510, the Quality Endorsement Engine 206 determines that a target member account satisfies at least one quality endorser requirement with respect to a reference member account. According to an example embodiment, upon detecting the reference member account has posted content to the social network service, the Quality Endorsement Engine 206 filters (e.g., analyzes the data associated with a plurality of member accounts) a plurality of member accounts to identify a target member account that is classified as a quality endorser. It is understood that the target member account can be classified as a quality endorser prior to the reference member account posting content—or in response to posting of the content.

To be classified as a quality endorser, any respective member account may have an affiliation overlap with the reference member account or there may be a connection strength value between that respective member account and the reference member account that satisfies (e.g., is equal to or exceeds) a threshold connection strength value. In addition, the respective member account may have a skill reputation score value that satisfies a threshold skill reputation score value and the respective member account meets the criteria of a people leader classification.

To identify a presence of affiliation overlap between the target member account and the reference member account, the Quality Endorsement Engine 206 accesses profile data of both the reference and target member accounts to determine whether that the members associated with the reference and target member accounts attended an educational institution during a first same period of time and/or were employed by an organization during a second same period of time. With regard to determining the connection strength value between the reference and target member accounts, the Quality Endorsement Engine 206 accesses profile data attributes and social network connection graphs of the reference and target member accounts to identify a first number of same profile data attributes shared between the first and second member accounts, and to identify a second number of same social network connections, with other member accounts in the social network service, common to the respective social network connection graphs.

The Quality Endorsement Engine 206 determines a connection strength value, between the reference and target member accounts, based on the first number of similar profile data attributes and second number of same social network connections. The Quality Endorsement Engine 206 determines that the connection strength value is at least above (e.g., exceeds) a pre-selected percentile of a connection strength distribution of pre-calculated connection strength values between respective pairs of member accounts of a plurality of member accounts. For example, prior to the reference member account posting the content, the Quality Endorsement Engine 206 has already calculated respective connection strength values between various pairs of member accounts to generate a sample statistical distribution of connection strength values in the social network service. A pre-selected percentile of a connection strength distribution can be, for example, 75^{th} percentile. Therefore, the Quality Endorsement Engine 206 determines will determine whether the connection strength value between the reference and target member accounts is at or above the 75^{th} percentile in the sample statistical distribution of connection strength values.

The Quality Endorsement Engine 206 determines that the target member account has a skill reputation score value that satisfies a threshold skill reputation score value. The Quality Endorsement Engine 206 determines the skill reputation score value for the target member account based on at least one of a first number of other member accounts that have viewed the target member account's profile page, a second number of skill endorsements received by the target member account, or a third number indicating a professional seniority level of the target member account.

The Quality Endorsement Engine 206 determines that the target member account satisfies a people leader classification. The Quality Endorsement Engine 206 accesses profile data attributes of the target member account to determine at least one of: a presence of one or more keywords, in a job title of the target member account, that are correlated with a managerial role at an organization of a certain size (e.g., with at least 200 employees), or a presence of one or more professional seniority keywords in a current job title, of the second member account, with an organization of a certain size (e.g., no more than 10 employees).

At operation 515, the Quality Endorsement Engine 206 generates an endorsement prompt for the target member account. The Quality Endorsement Engine 206 generates an endorsement prompt for display in a social network content feed of the target member account. The Quality Endorsement Engine 206 generates selectable functionalities that are included in the endorsement prompt. Each selectable functionality corresponds to a Skills identifier that matches a topic tag from a portion of content extracted from the content posted by the reference member account.

At operation 520, the Quality Endorsement Engine 206 causes concurrent and/or proximate display of content posted by the reference member account and the endorsement prompt. Upon detecting a selection of a particular Skills identifier by the target member account from the endorsement prompt, the Quality Endorsement Engine 206 classifies the selection as a Skills endorsement for the reference member account. The Quality Endorsement Engine 206 updates one or more database records associated with the endorser or the member being endorsed to indicate the endorsement and/or the skills endorsed.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

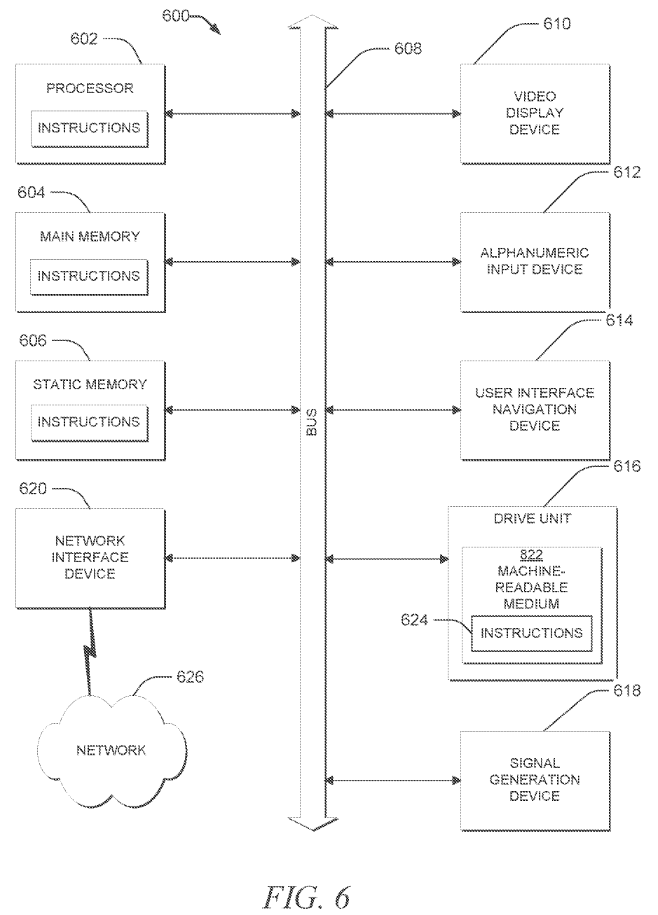

FIG. 6 is a block diagram of an example computer system 600 on which operations, actions and methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 600 includes a processor 602 (e.g., a central processing unit (CPU), a graphics processing unit (GPU) or both), a main memory 604, and a static memory 606, which communicate with each other via a bus 608. Computer system 600 may further include a video display device 610 (e.g., a liquid crystal display (LCD) or a cathode ray tube (CRT)). Computer system 600 also includes an alphanumeric input device 612 (e.g., a keyboard), a user interface (UI) navigation device 614 (e.g., a mouse or touch sensitive display), a disk drive unit 616, a signal generation device 618 (e.g., a speaker) and a network interface device 620.

Disk drive unit 616 includes a machine-readable medium 622 on which is stored one or more sets of instructions and data structures (e.g., software) 624 embodying or utilized by any one or more of the methodologies or functions described herein. Instructions 624 may also reside, completely or at least partially, within main memory 604, within static memory 606, and/or within processor 602 during execution thereof by computer system 600, main memory 604 and processor 602 also constituting machine-readable media.

While machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices, magnetic disks such as internal hard disks and removable disks, magneto-optical disks; and CD-ROM and DVD-ROM disks.

Instructions 624 may further be transmitted or received over a communications network 626 using a transmission medium. Instructions 624 may be transmitted using network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wifi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system, comprising:
one or more hardware processors;
a machine-readable medium for storing instructions that, when executed by the one or more hardware processors of a machine, cause the machine to perform operations comprising:
extracting content portions from content, accessible on a social network service, associated with a first member account;
identifying at least one pre-defined skills identifier that corresponds to a respective topic of a respective content portion;
determining that a second member account satisfies at least one quality endorser requirement with respect to the first member account;
generating an endorsement prompt for the second member account, the endorsement prompt including the at least one pre-defined skills identifier that corresponds to the respective topic of the respective content portion; and
causing concurrent display of the content and the endorsement prompt in a social network content feed of the second member account in a user interface of a client device associated with the second member account.

2. The computer system of claim 1, wherein identifying at least one pre-defined skills identifier that corresponds to a respective topic of a respective content portion comprises:
for each respective content portion:
generating a topic tag based on subject matter in the respective content portion;
standardizing the topic tag to a particular pre-defined skills identifier from a plurality of pre-defined skills identifiers; and
classifying the particular pre-defined skills identifier as available for inclusion in the endorsement prompt.

3. The computer system of claim 1, wherein the determining that the second member account satisfies at least one quality endorser requirement with respect to the first member account comprises:
accessing profile data of both the first and second member accounts;
determining at least one of a presence of affiliation overlap, or a connection strength value between the first and second member accounts that satisfies a threshold connection strength value; and
determining at least one of: the second member account has a skill reputation score value that satisfies a threshold skill reputation score value, or the second member account satisfies a people leader classification.

4. The computer system of claim 3, wherein the determining of the presence of affiliation overlap comprises:
determining a presence of similarities between profile data attributes of the first and second member accounts, comprising:
determining that the members associated with the first and second member accounts attended an educational institution during a first same period of time; and
determining that the members associated with the first and second member accounts were employed by an organization during a second same period of time.

5. The computer system of claim 4, wherein the determining of the presence of the connection strength value between the first and second member accounts that satisfies a threshold connection strength value comprises:
accessing profile data attributes and social network connection graphs of the first and second member accounts;
identifying a first number of same profile data attributes shared between the first and second member accounts;
identifying a second number of same social network connections, with other member accounts in the social network service, common to the respective social network connection graphs of the first and second member accounts;
determining a connection strength value between the first and second member accounts based on the first and second numbers; and
determining that the connection strength value is at least above a pre-selected percentile of a connection strength distribution of pre-calculated connection strength values between respective pairs of member accounts of a plurality of member accounts.

6. The computer system of claim 3, wherein the determining that the second member account has the skill reputation score value that satisfies the threshold skill reputation score value comprises:
determining the skill reputation score value based on at least one of a first number of other member accounts that have viewed the second member account's profile page, a second number of skill endorsements received by the second member account, or a third number indicating a professional seniority level of the second member account; and
determining that the skill reputation score value satisfies the threshold skill reputation score value.

7. The computer system of claim 6, wherein the determining that the second member account satisfies the people leader classification comprises:
accessing profile data attributes of the second member account to determine at least one of:
a presence of one or more keywords, in a job title of the second member account, correlated with a managerial role at an organization with at least 200 employees; or
a presence of one or more professional seniority keywords in a current job title, of the second member account, with an organization of no more than 10 employees.

8. A non-transitory computer-readable medium comprising instructions that, when executed by one or more hardware processors of a machine, cause the machine to perform operations comprising:
extracting content portions from content, accessible on a social network service, associated with a first member account;
identifying at least one pre-defined skills identifier that corresponds to a respective topic of a respective content portion;
determining a second member account satisfies at least one quality endorser requirement with respect to the first member account;
generating an endorsement prompt for the second member account, the endorsement prompt including the at least one pre-defined skills identifier that corresponds to the respective topic of the respective content portion; and
causing concurrent display of the content and the endorsement prompt in a social network content feed of the second member account in a user interface of a client device associated with the second member account.

9. The computer-readable medium of claim 8, wherein the identifying of the at least one pre-defined skills identifier that corresponds to the respective topic of the respective content portion comprises:
for each respective content portion:
generating a topic tag based on subject matter in the respective content portion;
standardizing the topic tag to a particular pre-defined skills identifier from a plurality of pre-defined skills identifiers; and
classifying the particular pre-defined skills identifier as available for inclusion in the endorsement prompt.

10. The computer-readable medium of claim 8, wherein the determining the second member account satisfies at least one quality endorser requirement with respect to the first member account comprises:
accessing profile data of both the first and second member accounts;
determining at least one of a presence of affiliation overlap, or a connection strength value between the first and second member accounts that satisfies a threshold connection strength value; and
determining at least one of: the second member account has a skill reputation score value that satisfies a threshold skill reputation score value, or the second member account satisfies a people leader classification.

11. The computer-readable medium of claim 10, wherein the determining of the presence of affiliation overlap comprises:
determining a presence of similarities between profile data attributes of the first and second member accounts, comprising:
determining that the members associated with the first and second member accounts attended an educational institution during a first same period of time; and
determining that the members associated with the first and second member accounts were employed by an organization during a second same period of time.

12. The computer-readable medium of claim 11, wherein the determining of the connection strength value between the first and second member accounts that satisfies the threshold connection strength value comprises:
accessing profile data attributes and social network connection graphs of the first and second member accounts;
identifying a first number of same profile data attributes shared between the first and second member accounts;
identifying a second number of same social network connections, with other member accounts in the social network service, common to the respective social network connection graphs of the first and second member accounts;
determining a connection strength value between the first and second member accounts based on the first and second numbers; and
determining the connection strength value is at least above a pre-selected percentile of a connection strength distribution of pre-calculated connection strength values between respective pairs of member accounts of a plurality of member accounts.

13. The computer-readable medium of claim 10, wherein the determining that the second member account has the skill reputation score value that satisfies the threshold skill reputation score value comprises:
determining the skill reputation score value based on at least one of a first number of other member accounts that have viewed the second member account's profile page, a second number of skill endorsements received by the second member account, or a third number indicating a professional seniority level of the second member account; and
determining that the skill reputation score value satisfies the threshold skill reputation score value.

14. The computer-readable medium of claim 13, wherein the determining that the second member account satisfies the people leader classification comprises:
accessing profile data attributes of the second member account; and
determining at least one of:
a presence of one or more keywords, in a job title of the second member account, correlated with a managerial role at an organization with at least 200 employees, or
a presence of one or more professional seniority keywords in a current job title, of the second member account, with an organization of no more than 10 employees.

15. A computer-implemented method, comprising:
extracting content portions from content, accessible on a social network service associated with a first member account;
identifying at least one pre-defined skills identifier that corresponds to a respective topic of a respective content portion;
determining a second member account satisfies at least one quality endorser requirement with respect to the first member account;
generating an endorsement prompt for the second member account, the endorsement prompt including the at least one pre-defined skills identifier that corresponds to the respective topic of the respective content portion; and
causing concurrent display of the content and the endorsement prompt in a social network content feed of the second member account in a user interface of a client device associated with the second member account.

16. The computer-implemented method of claim 15, wherein the identifying of the at least one pre-defined skills identifier that corresponds to the respective topic of the respective content portion comprises:
for each respective content portion:
generating a topic tag based on subject matter in the respective content portion;
standardizing the topic tag to a particular pre-defined skills identifier from a plurality of pre-defined skills identifiers; and
classifying the particular pre-defined skills identifier as available for incursion in the endorsement prompt.

17. The computer-implemented method of claim 15, wherein the determining that the second member account satisfies at least one quality endorser requirement with respect to the first member account comprises:
accessing profile data of both the first and second member accounts;
determining at least one of a presence of affiliation overlap, or a connection strength value between the first and second member accounts that satisfies a threshold connection strength value; and
determining at least one of: the second member account has a skill reputation score value that satisfies a threshold skill reputation score value, or the second member account satisfies a people leader classification.

18. The computer-implemented method of claim 17, wherein the determining of the presence of affiliation overlap comprises:
determining a presence of similarities between profile data attributes of the first and second member accounts, comprising:
determining that the members associated with the first and second member accounts attended an educational institution during a first same period of time; and
determining that the members associated with the first and second member accounts were employed by an organization during a second same period of time.

19. The computer-implemented method of claim 18, wherein the determining of the connection strength value between the first and second member accounts that satisfies the threshold connection strength value comprises:
accessing profile data attributes and social network connection graphs of the first and second member accounts;
identifying a first number of same profile data attributes shared between the first and second member accounts;
identifying a second number of same social network connections, with other member accounts in the social network service, common to the respective social network connection graphs of the first and second member accounts;
determining a connection strength value between the first and second member accounts based on the first and second numbers; and
determining the connection strength value is at least above a pre-selected percentile of a connection strength distribution of pre-calculated connection strength values between respective pairs of member accounts of a plurality of member accounts.

20. The computer-implemented method of claim 17, wherein the determining that the second member account has the skill reputation score value that satisfies the threshold skill reputation score value comprises:
determining the skill reputation score value based on at least one of a first number of other member accounts that have viewed the second member account's profile page, a second number of skill endorsements received by the second member account, or a third number indicating a professional seniority level of the second member account; and
determining that the skill reputation score value satisfies the threshold skill reputation score value.
